(19) United States
(12) Patent Application Publication
(10) Pub. No.: US 2019/0127085 A1
(43) Pub. Date: May 2, 2019

(54) PAYLOAD EXCHANGE FACILITATING CONNECTOR

(71) Applicant: AIROBOTICS LTD., Petah Tikva (IL)

(72) Inventors: Ran KRAUSS, Beer Sheva (IL); Meir KLINER, Ramat Gan (IL)

(21) Appl. No.: 16/310,745

(22) PCT Filed: Jun. 18, 2017
(86) PCT No.: PCT/IL2017/050675

§ 371 Date: Dec. 17, 2018

(30) Foreign Application Priority Data
Jun. 20, 2016 (IL) 246357

(51) Int. Cl. B64F 1/32; B64C 39/02; B64D 1/22

(52) U.S. Cl. CPC B64F 1/32; B64C 39/024; B64C 2201/128; B64C 2201/042; B64C 2201/123; B64D 1/22

(57) ABSTRACT

A payload exchange facilitating connector module, comprises: a) a structure secured to a payload; b) a locking member operatively connected to said structure! c) a locking initiating element that is settable in force transmitting relation with said locking member! and d) two guiders configured to urge an interface element of two different external positioning components, respectively, to undergo linear and non-rotatable relative motion exclusively with respect to said structure, until said locking initiating element is set in force transmitting relation with said locking member to cause said locking member to become coupled with a dedicated element of a first of said positioning components, or following decoupling of said locking member from said dedicated element to facilitate payload exchange.

### FIELD OF THE INVENTION

The present invention relates to the field of drones and other autonomously flown aerial vehicles. More particularly, the invention relates to a connector that facilitates exchange of a payload carried by such drones.

### BACKGROUND OF THE INVENTION

The use of drones has significantly increased in recent years for various airborne missions such as data collection and image capturing, as well as for commercial activities including traffic management and the delivery of goods. Due to the small size of the drones, the capacity of a battery carried by the drones is limited, and consequently their flight range is limited.

Drones have an intrinsic flexibility as they may be used for different missions, for example the imaging device needed for daytime imaging is significantly different than the one used for nighttime imaging. For the delivery of goods, the payload is generally different from mission to mission.

Drones would be able to be used more efficiently if their battery or payload could be exchanged quickly, to facilitate the performance of additional missions during a given time period.

U.S. Pat. No. 9,280,038 discloses a platform for interchangeably mounting a payload to a base support of an unmanned aerial vehicle (UAV). In one embodiment, the platform includes a handheld support member configured to be releasably mechanically and electrically coupled to a gimbal assembly, which is coupled to an imaging device. However, the costs associated with employing a human operator are significantly greater than those required by a fully automatic system.

Some prior art systems, for example U.S. Pat. Nos. 9,139,310, 9,284,062, US 2016/0011592 and WO 2016/015301 are known for automatically exchanging the battery needed for powering a drone after becoming depleted; however, the robotic manipulator is configured to physically clamp or grasp the battery, necessitating a complicated and costly arrangement of links, joints and actuators to provide the required dexterity to effect such exchange operations. In addition, the manipulator is required to be positioned in sufficient proximity to a movable holding station such as a carousel or elevator to enable the exchange operation, requiring added costs to assemble and maintain the movable holding station. Alternatively, linear positioning equipment such as a carriage or track and corresponding controllers are needed to accurately direct the manipulator to a target destination to facilitate the exchange operation.

As to the exchange of payloads, the payloads are typically designed for handheld swapping operations. Alternatively, a dedicated robotic manipulator is used for each type of payload in order to be able to engage the payload and then physically remove it from the drone, due to the significant difference in configuration from one payload to another. Many times the payloads themselves have to be adapted for engagement by robotic manipulators, such as being configured with slots or other engageable elements, to further add to the costs involved in a prior art exchange operation.

It is an object of the present invention to provide a fully automatic system for exchanging the payload of a drone.

It is an additional object of the present invention to provide a connector that facilitates the automatic exchange of a drone's payload.

It is an additional object of the present invention to provide a payload exchange system that is not dependent upon a predetermined robot position to ensure a reliable and accurate payload exchange operation.

It is yet an additional object of the present invention to provide a cost effective payload exchange system that minimizes for example the number of robotic arms that need to be employed.

Other objects and advantages of the invention will become apparent as the description proceeds.

### SUMMARY OF THE INVENTION

The present invention provides a payload exchange facilitating connector module, comprising a structure secured to a payload, a locking member operatively connected to said structure, a locking initiating element that is settable in force transmitting relation with said locking member, two guiders configured to urge an interface element of two different external positioning components, respectively, to undergo linear and non-rotatable relative motion exclusively with respect to said structure until said locking initiating element is set in force transmitting relation with said locking member to cause said locking member to become coupled with a dedicated element of a first of said positioning components, or following decoupling of said locking member from said dedicated element to facilitate payload exchange.

In one aspect, said structure is engageable by the interface element of each of said two different positioning components such that said structure is engageable by the interface element of only one of said two different positioning components at any given time, and is engageable by a second of said positioning components when said locking member is decoupled from said first positioning components to facilitate payload exchange.

In one embodiment, the connector module comprises a structure that is externally securable to a payload which is loadable onto an unmanned vehicle, said structure configured with at least two linearly extending entryways; a flexible locking panel with one free end that is unattached to said structure; and a flexion initiating element that is settable in force transmitting relation with said locking panel, wherein a first of said entryways is configured to receive therewithin either a protruding part of a first handle fixed to said unmanned vehicle or a protruding part of a second handle fixed to a holding station, and a second of said entryways is configured to receive therewithin a grabber of a robotic arm, wherein the free end of said locking panel is engageable with said first handle to secure said connector module to said unmanned vehicle or with said second handle to secure said connector module to said holding station, wherein said flexion initiating element is normally spaced from said locking panel and is settable in force transmitting relation therewith following linear insertion of said grabber within said second entryway to cause said locking panel to flex and to become disengaged from said first handle or from said second handle, wherein said structure is engageable by said grabber when said locking panel is disengaged from said first handle or from said second handle to facilitate transport of said connector module and subsequent payload exchange.

The present invention is also directed to a payload exchange system, comprising said connector module, and a robotic arm for transporting the connector module when the locking member is decoupled from the first positioning components, wherein a terminal link of said robotic arm comprises a coupling unit for controllably setting the locking initiating element in force transmitting relation with the locking member following guider cooperating linear displacement of the interface element of the second of said positioning components.

### BRIEF DESCRIPTION OF THE DRAWINGS

In the drawings:

FIG. 1 is a perspective view from the rear of a connector module, according to one embodiment of the present invention, as it is secured to a payload;

FIG. 2 is a perspective view from the top and rear of the connector module of FIG. 1, after being detached from the payload;

FIG. 3 is a perspective view from the top and front of the connector module of FIG. 1, after being detached from the payload;

FIG. 4 is a front view of the connector module of FIG. 1, after being detached from the payload;

FIG. 5 is a perspective view of a robotic arm usable for performing payload exchange operations in conjunction with the connector module of FIG. 1;

FIG. 6 is a perspective view from the top of a coupling unit housed within a terminal link of the robotic arm of FIG. 5, according to one embodiment of the invention;

FIG. 7 is a top view of the coupling unit of FIG. 6;

FIG. 8 is a schematic illustration of a payload exchange system, according to one embodiment of the invention;

FIG. 9 is a perspective view from the bottom of a handle;

FIG. 10 is a perspective view from the top when a connector module and the handle of FIG. 9 are in coupled relation;

FIG. 11 is a perspective view from the top when a connector module is decoupled and spaced from the handle of FIG. 9;

FIG. 12 is a perspective view of the robotic arm of FIG. 5 as it is transporting a payload.

### DETAILED DESCRIPTION OF PREFERRED EMBODIMENTS

The present invention is a universal connector that facilitates automatic exchange or removal of a payload carried by a drone upon completion of a flying mission, or carried by any other suitable unmanned vehicle.

As referred to herein, a “payload” is a unit which is removably or interchangeably appendable to the unmanned vehicle, for example within a dedicated recess or cavity. Non-limitating examples of a payload include sensing devices, imaging devices, batteries, deliverable packages and weapons. When the payload is an electronic device, an onboard processor may be in data communication therewith to control operation of the payload or to store and process acquired data.

The connector is configured to be an appendage to the payload, according to one embodiment, without requiring any modifications to the payload which would normally be needed by prior art automatic payload exchange apparatus to engage the payload and to thereby facilitate the payload exchange. As the connector appendage is easily securable to a payload and to a battery, a standard connector may be used for all exchange operations, and may be advantageously connectable with both the corresponding handle of a drone or of a docking station and with the grabber of a robotic arm. Thus the payload is quickly and accurately removable from the drone and mountable onto the docking station, and conversely a new payload is removable from a different handle of the docking station, for example located at a holding station, and connectable to the drone handle.

In a payload exchange system, a terminal link of the robotic arm that includes the grabber cooperates with the connector, and performs the following three actions: (1) a trans-connector movement whereby the grabber crosses at least one border of the connector, whether internally within the connector or externally thereto, (2) a lock interaction to couple the connector with a handle or to decouple the connector from a handle at a time following or prior to the trans-connector movement, and (3) a transfer action during removal of the connector together with the payload with which it is secured from a handle or transport thereof to another handle. The lock interaction may be a physical action such as a screwing or twisting movement or an action triggered by contact, an electrically initiated action, or a signal-transmitted action.

The uncomplicated connector configuration facilitates the performance of short linear and non-rotatable motions by the robotic arm during a trans-connector movement or a transfer action to obviate the need of an expensive high-dexterity gripper.

To the extent that the term “handle” is employed herein, it should be understood that this term refers to a positioning component external to the connector, whether stationary or movable, provided with an element that is interfaceable with the connector. The interface element is urged by a connector-specific guider to undergo relative linear motion with respect to the connector structure at a time that generally does not coincide with the lock interaction, whereby a locking initiating element is set in force transmitting relation with a locking member that is adapted to become coupled with the handle.

The guider may be passive in nature, for example hollowed out from the connector structure to receive the interface element or protruding from the connector structure to linearly guide the generally complementary shaped interface element. One way to prevent rotary motion is by configuring a protruding part with a discontinuous shape in cross section and an element to receive the protruding part with a shape that is complementary to the protruding part. Alternatively, the guider may be active, configured with a controlled electromechanical component that engages with, and causes relative linear displacement of, the interface element.

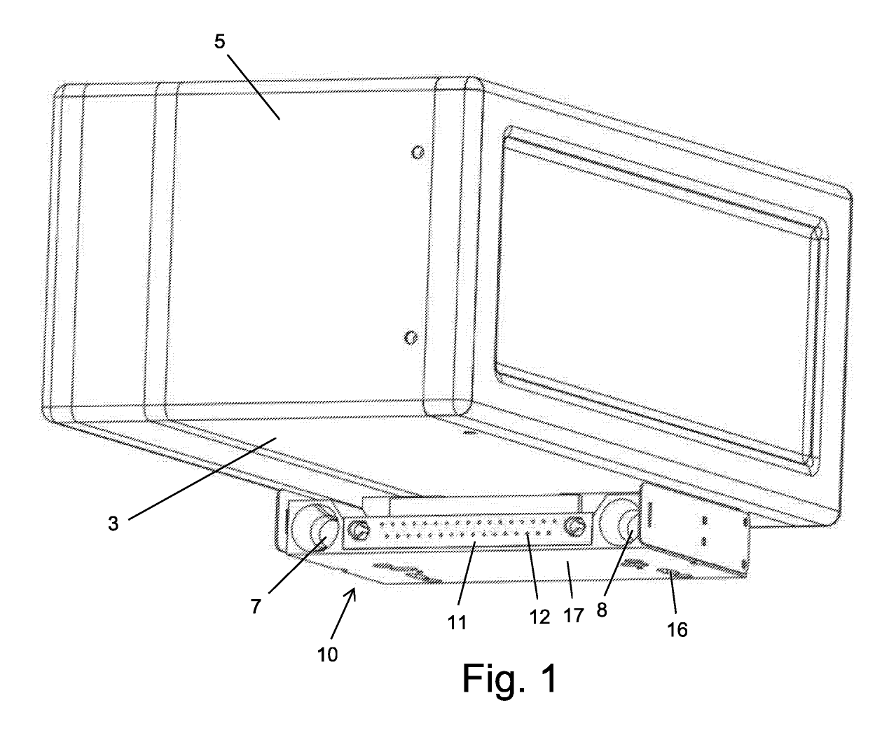

FIG. 1 illustrates a connector module 10, according to one embodiment of the present invention, as it is secured to a battery module 5 used to power a drone. Connector module 10 has two laterally spaced conical entryways 7 and 8 within which two protruding parts, respectively, of a handle are introducible to initiate a coupling operation, as will be described hereinafter. Interposed between the two entryways 7 and 8 is a rearwardly facing panel 11 formed with a plurality of female connector sockets 12, e.g. 33 sockets, each of which is connected to a corresponding pin extending inwardly within the interior of connector module 10, to provide for an electrical connection with given contacts of battery module 5. In this fashion, power and data may be readily transmitted to a suitable onboard receiver, when battery module 5 is mounted within a cavity formed within the drone and coupled with corresponding male connectors. Typical data that is transmittable includes battery status, including remaining battery capacity, remaining battery energy, instantaneous battery current and instantaneous battery temperature. Connector module 10 is shown to be rectilinear; however, any other connector shape is also in the scope of the invention.

Securing means 6 are provided to interface between connector module 10 and the underside 3 of battery module 5. Securing means 6 may be releasable, such as screwed fasteners, or alternatively may be permanently applied, e.g. by adhesion or welding.

Connector module 10 may be similarly used in order to be secured to a payload. Permanently applied securing means are of great utility when the same payload is frequently reused for the same type of mission, but has to be occasionally replaced to allow the drone to perform a different mission. Control commands may be sent to the payload from the onboard computer via connector sockets 12, or alternatively, data acquired by the payload may be transmitted via connector sockets 12 and saved in a suitable storage medium.

When securing means 6 are releasable, connector module 10 may be advantageously reused for different payloads. For example, when the payload comprises a plurality of individualized items, such as agricultural produce or prepackaged toys, the items are loaded into a customized container, e.g. a sturdy plastic container, and the releasable securing means are connected to mating elements of the container after being introduced through mounting openings 16 of the connector module underside 17, or are inserted within corresponding apertures of the container and tightened.

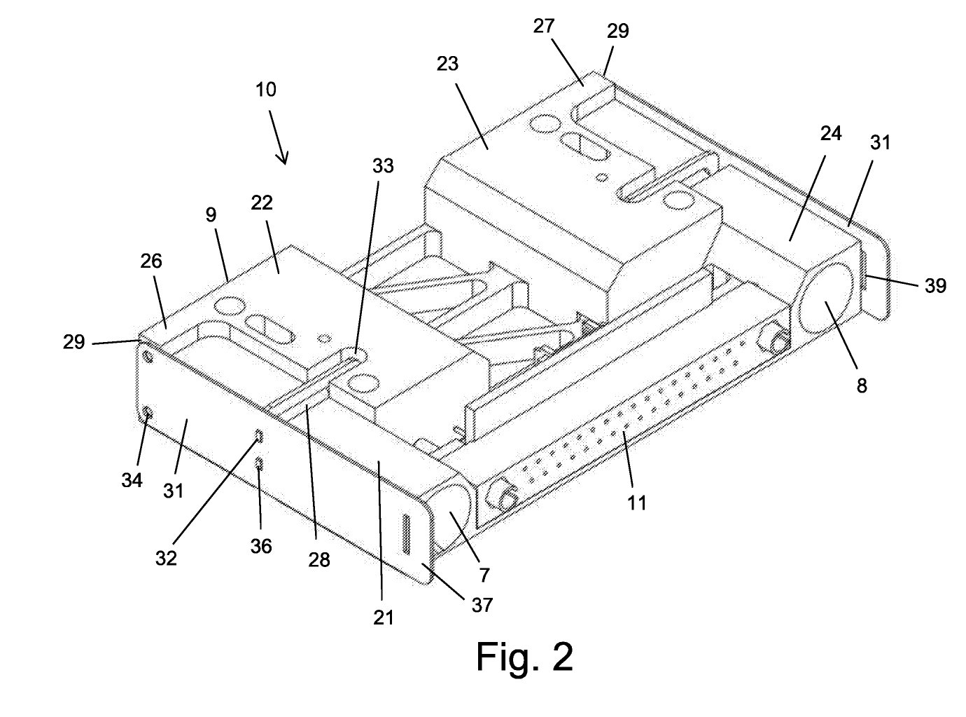

The structure of connector module 10 will now be described with reference first to FIG. 2.

Connector module 10 is configured with four guide blocks 21-24, each of which being formed with a longitudinally extending entryway, i.e. extending in the direction between frontwardly facing panel 9 and rearwardly facing panel 11.

Guide blocks 21 and 24 adjoining and coplanar with rear panel 11 are positioned at a laterally outwardly region of connector module 10, and the spacing therebetween defines the length of rear panel 11. Laterally spaced guide blocks 22 and 23 adjoining front panel 9 are contiguous with the inner side of guide blocks 21 and 24, respectively. The bottom surface of each of guide blocks 21-24 is coplanar.

Guide blocks 22 and 23 are higher than guide blocks 21 and 24, to define the upper surface of front panel 9. Thin elongated portions 26 and 27 of panel 9 extend laterally outwardly from guide blocks 22 and 23, respectively, to define a corresponding lateral wall 29. The front edge of guide blocks 21 and 24 abuts elongated portions 26 and 27, respectively.

Entryways 7 and 8 bored in guide blocks 21 and 24, respectively, are adapted to admit therethrough a corresponding protruding part of a drone or of a docking station, depending on the stage of the exchange operation currently being performed. A terminal portion of continuous entryways 7 and 8 is also bored in elongated portions 26 and 27, respectively, to allow for large dimensioned protruding parts.

Connector module 10 also has two flexible and rectangular locking panels 31, which may be made for example of thin rigid plastic or sheet metal. Each panel 31, which is in abutting relation with one of guide blocks 21 and 24 and is generally the same height as guide blocks 22 and 23, has an attached end connected to a corresponding lateral wall 29 by fasteners 34 and an unattached end 37 that longitudinally protrudes from rear panel 11. A locking aperture 39, e.g. rectangular, is formed in unattached end 37.

The upper surface of each of guide blocks 22 and 23 has a laterally extending recess 33, e.g. semielliptical, which is recessed until the upper surface of guide blocks 21 and 24. An elongated, laterally extending flexion initiating element 28 is received within recess 33 while being supported by the upper surface of the adjacent guide block, and is attached, at its outer end, to locking panel 31 at an aperture 32 which is centrally located between fasteners 34 and locking aperture 39. Flexion initiating element 28 may be further attached to locking panel 31 at an aperture 36 located below aperture 32.

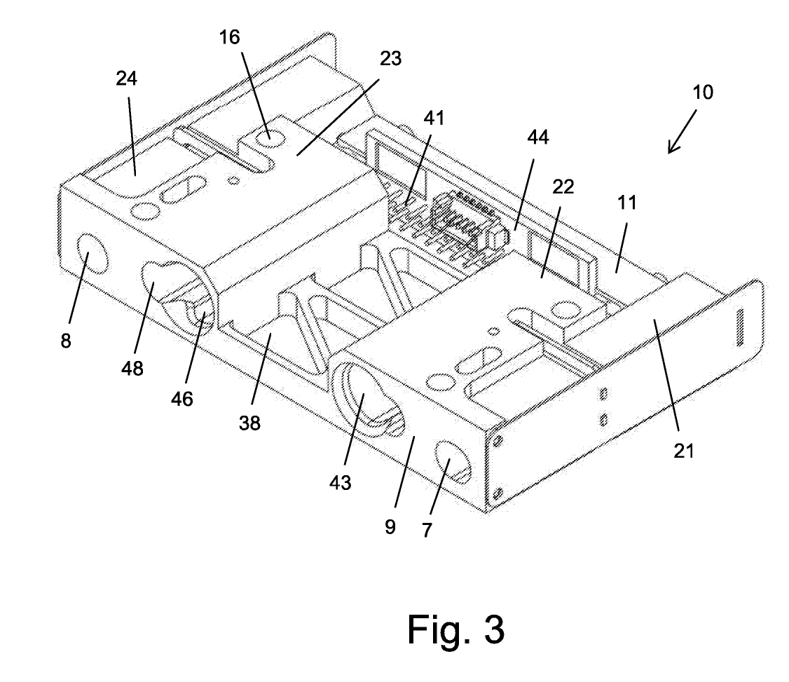

As shown in FIG. 3, longitudinally extending entryways 43 and 46 are formed in guide blocks 22 and 23, respectively, and are used to admit therethrough a corresponding grabber of the robotic arm. These entryways 43 and 46, which are accessible via front panel 9, also include a secondary bore 48 outwardly positioned from, but in communication with, the main entryway region to enlarge the lateral dimension of the entryway. Mounting openings 16 are formed in a solid region of guide blocks 22 and 23 that is between the two formed entryways.

Although the connector module is described as being monolithic and configured with four entryways, two for the admission of handle related protruding parts and two for the admission of robotic arm grabbers, it will be appreciated that the invention is applicable for any other suitable number of entryways or guiders. Likewise the connector module may be separated into two or more sections, for example one section to admit a protruding part and the other section to receive a grabber while a locking member interfaces between the two sections.

A vertical mounting board 44 for the various pins 41 connected to corresponding female connector sockets is shown to be in abutting relation with rear panel 11. Wires may extend from each pin 41, through the interior region 38 located between mounting blocks 22 and 23, to the interior of the payload in order to make a desired electrical connection. Such electrical connections are useful for the transmission of payload data, such as sensor data acquired by the payload including image data, motion data and position data, payload status data as to whether for example the payload is activated, deactivated, is currently performing an operation, or has completed a commanded operation, and control signals.

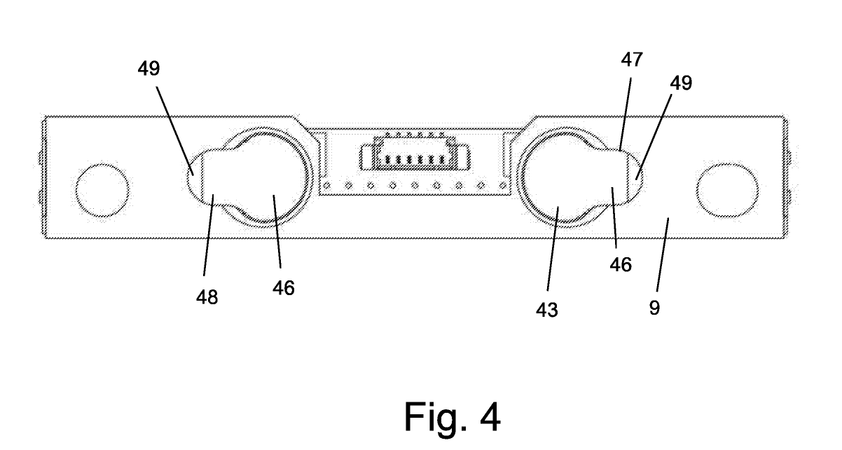

As shown in FIG. 4, a vertically oriented tab 49 connected to flexion initiating element 28 (FIG. 2), and downwardly extending therefrom, is normally positioned within secondary bore 48 of each of entryways 43 and 46, for use during an exchange operation.

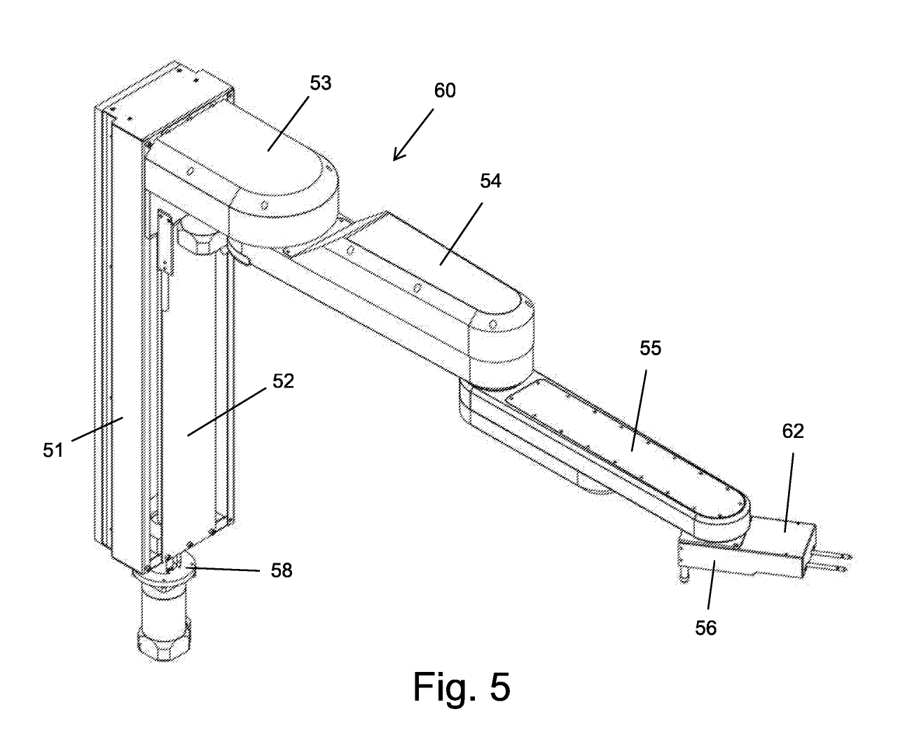

The connector module is adapted to be disengaged from a first handle and subsequently engaged with a second handle by means of a dedicating coupling unit 62 housed within the terminal link 56 of a robotic arm 60 illustrated in FIGS. 5-7.

Robotic arm 60 shown in FIG. 5 has five degrees of freedom, being configured with four serially linked links 53-56 wherein each of the links 54-56 is connected by a revolute joint of a mutually parallel axis to permit independent rotation about the joint axis of the preceding link. Link 53 in turn is connected by a prismatic joint to slider 52 to permit vertical translation. The housing 51 of slider 52 is rotatable about a vertical swivel axis of pedestal 58. The motion of each link is controlled by a motorized action initiated by a wired or wireless command. This robotic arm configuration allows terminal link 56 to be coupled with a connector module located at a varying distance from pedestal 58, from a small distance of only a few centimeters to a large distance of 5 m or more.

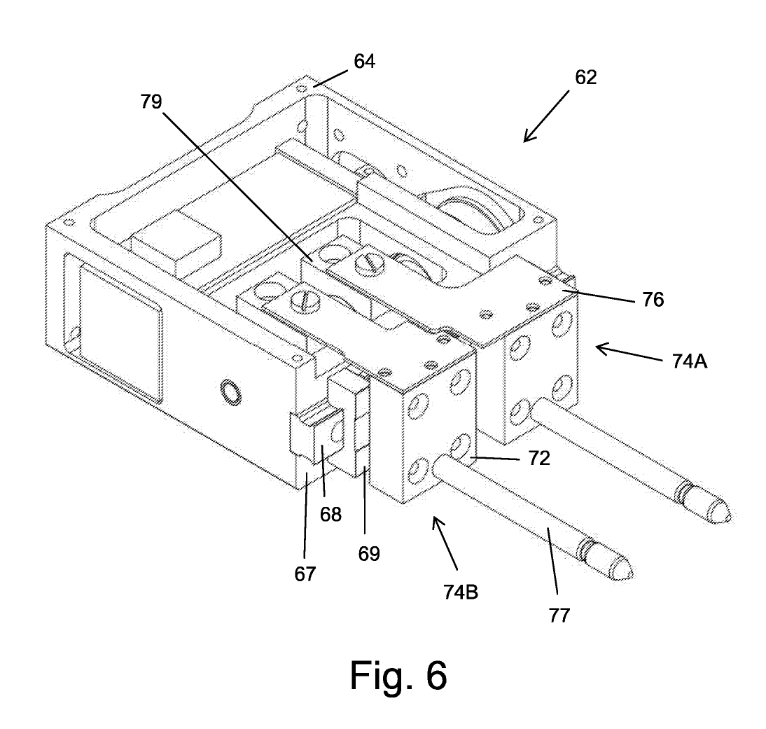

Coupling unit 62 which is housed within the terminal link is illustrated in FIG. 6. Hollow rectilinear frame 64 of coupling unit 62 has a vertical face 67, which is provided with a horizontal rail 68 that is embraced by two separated C-shaped attachments 69. The vertical segment 72 of an L-shaped bracket 74 from which protrudes a corresponding tubular grabber 77 is connected to each of these attachments 69 to permit horizontal bracket displacement. The horizontal segment 76 of each bracket 74A or 74B is connected to a corresponding fixture 79.

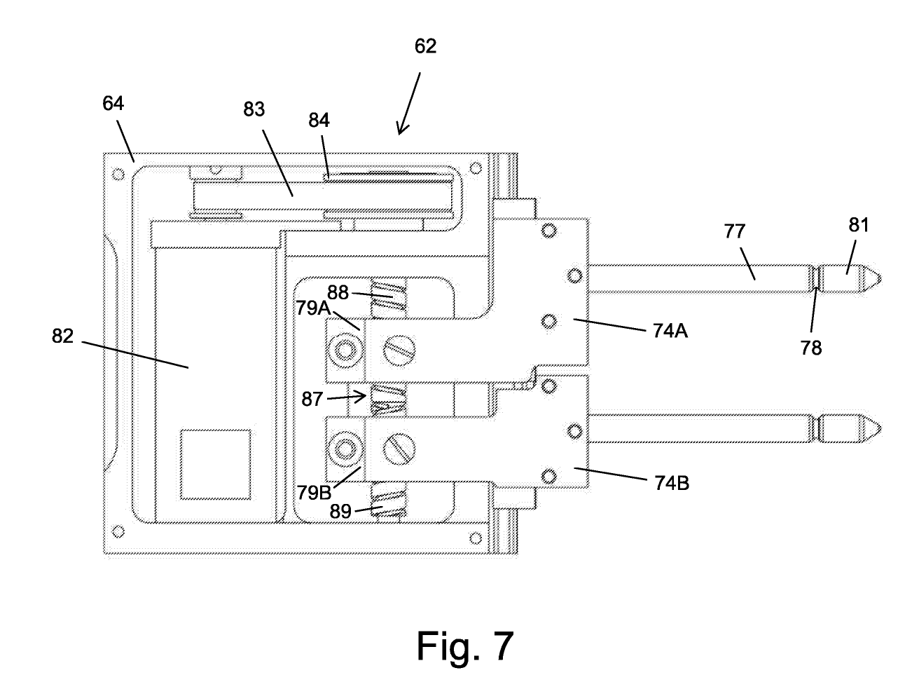

As shown in FIG. 7, coupling unit 62 also comprises motor 82 housed within frame 64 and rotatably mounted pulley 84. Belt 83 transmits the torque output by motor 82 to pulley 84, causing twin-lead screw 87 which is coaxial with pulley 84 and rotatably mounted in frame 64 to rotate as well. Twin-lead screw 87 has two axially spaced threaded portions 88 and 89 of opposite handedness. Operation of motor 82 will therefore cause screw 87 to rotate, and will also cause the two fixtures 79A-B threadedly engaged with the two threaded portions 88 and 89, respectively, to be displaced in opposite directions, resulting in opposing motion of brackets 74A and 74B and of the grabbers 77, respectively.

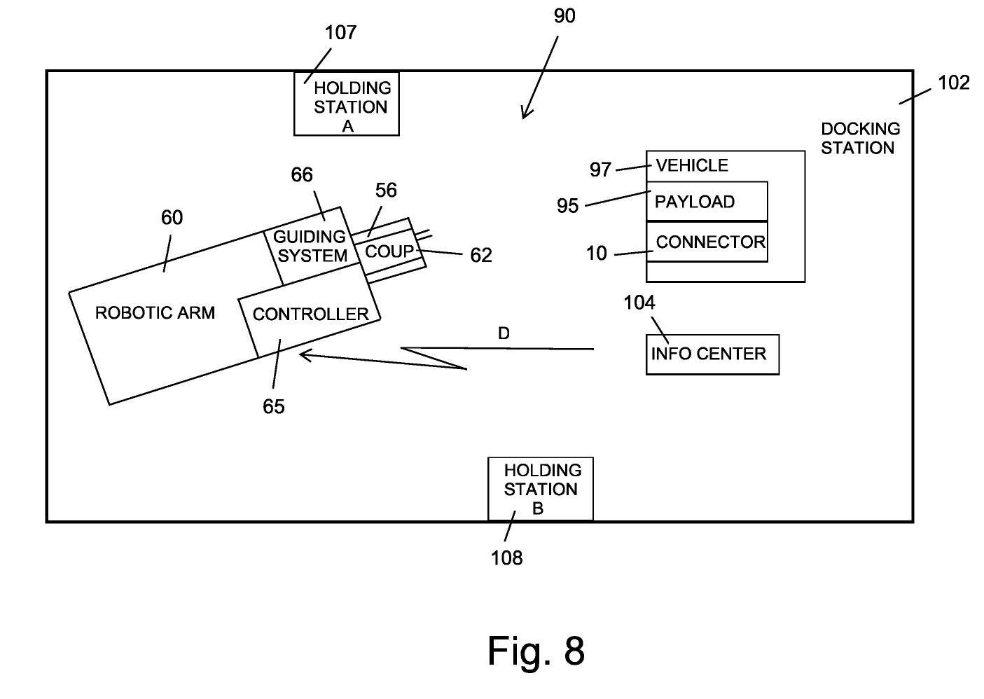

With reference to FIG. 8, payload exchange system 90 comprising connector module 10 secured to payload 95, and terminal link 56 of robotic arm 60, and particularly coupling unit 62 thereof, for controllably interfacing with connector module 10 is suitable for accurately and reliably performing an exchange operation.

Payload exchange system 90 also comprises an information center 104 associated with docking station 102 for acquiring data as to the docking status of an unmanned vehicle 97 approaching docking station 102 and for transmitting a docking indicating signal D to the controller 65 of robotic arm 60 which is indicative that unmanned vehicle 97 carrying payload 95 has been fully docked and that an exchange operation may be initiated. Unmanned vehicle 97 may be an aerial vehicle such as a multi-rotor vehicle, a drone, an electrically powered vehicle, a fuel powered vehicle, a multi-wheeled or tracked land vehicle, a watercraft and an amphibious vehicle.

During an exchange operation, connector module 10 and payload 95 secured thereto are removed by robotic arm 60 from unmanned vehicle 97 and are transferred thereby to a first holding station 107 for used payloads that have undergone a completed mission. At first holding station 107, maintenance operations are performed with respect to the removed payload or data is retrieved therefrom, if the payload was configured to acquire data during the performed mission. As a replacement for the removed payload, an unused payload is removed by robotic arm 60 from second holding station 108 and is loaded thereby onto unmanned vehicle 97.

Holding stations 107 and 109 may be stationary to avoid the costs of assembling and maintaining a movable holding station, or alternatively may comprise movable equipment. If so desired, a single holding station for both used and unused payloads may be deployed at a same region.

The reliable performance of an exchange operation is contingent upon the ability to accurately locate and approach the entryways of connector module 10. A guiding system 66 provided with robotic arm 60 helps to accurately direct terminal link 56 to connector module 10, to ensure that each grabber will be introduced into a corresponding entryway, for example with a tolerance of only 1 mm or less. Guiding system 66 communicates with controller 65, and the motorized actuators of each link are commanded to operate, in response, to perform a coordinated displacement of robotic arm 60 until terminal link 56 is directed in the shortest possible time to connector module 10.

In one embodiment, guiding system 66 is based on encoder based position control whereby the real-time joint positions are known from encoder measurements and the target position of connector module 10 is acquired from information center 104. Additional displacement of the various links is then commanded by controller 65 in order to direct terminal link 56 to the target position.

In another embodiment, guiding system 66 comprises a vision system for providing a two-dimensional or three-dimensional image, including one or more cameras housed in a suitable region of robotic arm 60, an element of which possibly housed in terminal link 56, and a vision processor in data communication with controller 65. As robotic arm 60 continuously couples terminal link 56 during a work session with a similarly shaped connector module 10 secured to different payloads, the vision system is trained to visually identify the entryways as fiducial marks. When a fiducial mark enters the field of view of at least one of the cameras, controller 65 compares a found location of the identified fiducial mark within the field of view with a desired location of the fiducial mark within the field of view that corresponds to the orientation of the coupling module during introduction of a gripper into the correct entryway. Additional displacement of the various links is then commanded by controller 65 if there is a difference between the found location and the desired location.

A payload exchange operation will now be described with reference to FIGS. 3-4 and 7-12.

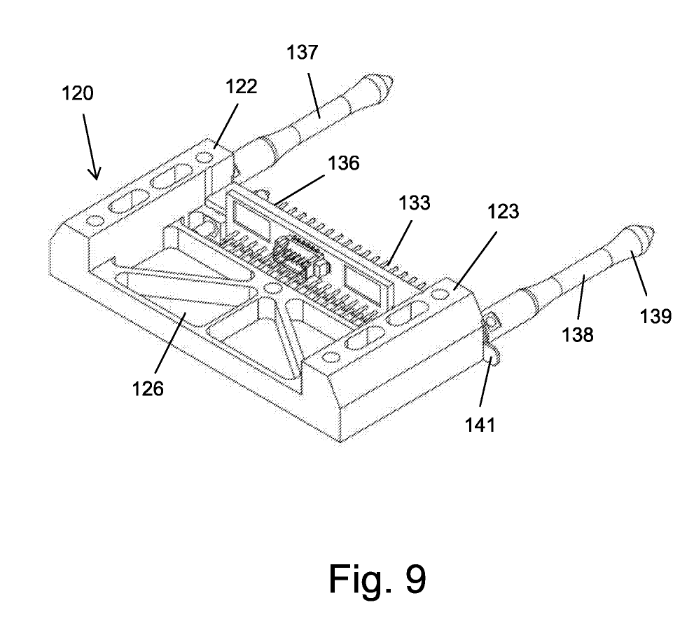

A bottom view of a handle 120 is illustrated in FIG. 9. An identically configured handle 120 is mounted at both an interior region of an unmanned vehicle and at a holding station to facilitate an exchange operation with the same coupling module.

Handle 120 has a C-shaped structure with two side beams 122 and 123, and with an upper cover 126 extending between side beams 122 and 123. A plurality of pins 133 protrude from the connector-facing face 136 of cover 126, and are adapted to couple with corresponding female connector sockets 12 (FIG. 1) of the connector module, so that a processing unit (not shown) connected to pins 133 will able to receive and process the data previously acquired by the payload.

Elongated protruding parts 137 and 138 of circular cross section extend outwardly from the connector-facing face 136 of side beams 122 and 123, respectively. The distal tip 139 of each of protruding parts 137 and 138 is conical to permit self-alignment within the conical entryways 7 and 8 shown in FIG. 1. The maximum thickness of each protruding part is less than the inner diameter of entryways 7 and 8.

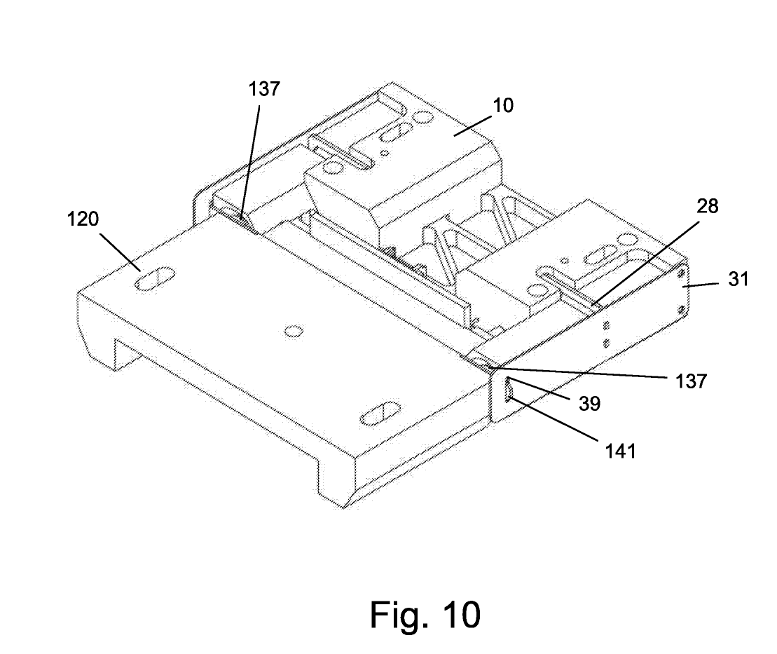

Handle 120 is also configured with a tab 141 laterally extending and outwardly protruding from the connector-facing face 136 of each of side beams 122 and 123. Tab 141 is engageable with the locking aperture 39 of the corresponding locking panel 31, to retain connector module 10 and handle 120 in mutually coupled relation after protruding parts 137 and 138 have been fully inserted within the corresponding entryways of connector module 10, as shown in FIG. 10.

After a docking indicating signal D has been transmitted to the robotic arm controller 65 (FIG. 8), the links of robotic arm 60 are controllably displaced by coordinated actions until the two grabbers 77 protruding from terminal link 56 are aligned with, but separated from, entryways 43 and 46 (FIG. 3), respectively, which are accessible via the front panel 9 of connector module 10. As a result of a continuous linear trans-connector movement effected by terminal link 56, the two grabbers 77 are inserted to a fullest extent within entryways 43 and 46, respectively.

Following the insertion of each grabber 77 within a corresponding entryway, controller 65 commands operation of motor 82, causing displacement of the two grabbers 77 in opposite laterally outward directions. During the laterally outward displacement, the two grabbers 77 pass through secondary bores 46 and 48, respectively, and strike the corresponding tab 49 of the flexion initiating element normally positioned therewithin. The laterally outward displacement of flexion initiating element 28 causes locking panel 31 to flex and to become disengaged from tab 141 of handle 120.

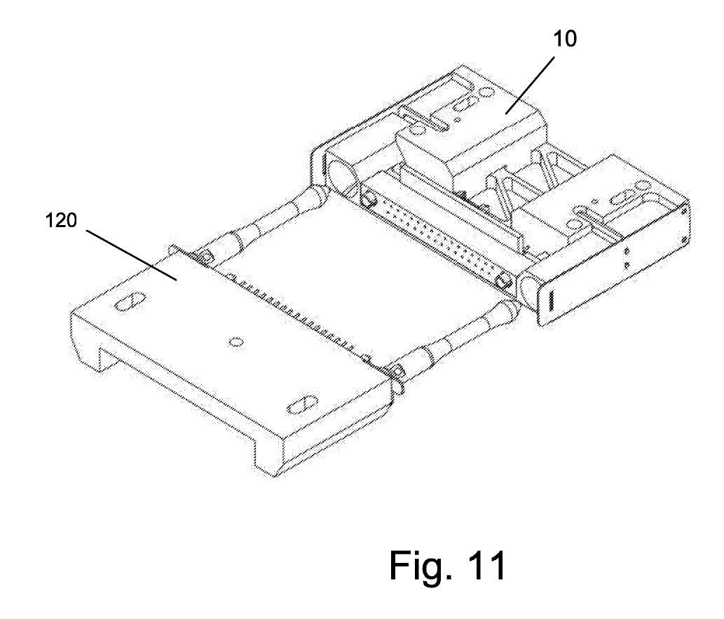

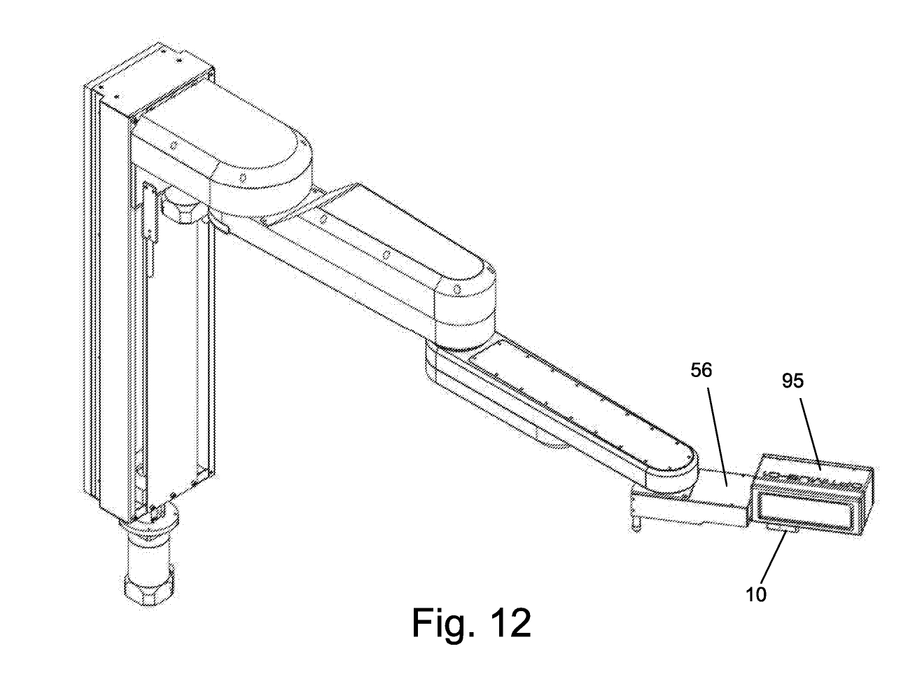

While locking panel 31 is disengaged from tab 141 of handle 120, controller 65 commands link 53 of robotic arm 60 (FIG. 5) to be displaced slightly vertically upwardly along slider 52, so that grabber 77 will contact the upper wall 47 of the corresponding secondary bore (FIG. 4) and will apply an upward force that causes connector module 10 to be displaced above handle 120. The upward displacement of connector module 10 prevents the reengagement of locking panel 31 with tab 141. Terminal link 56 is then commanded to be displaced rearwardly until connector module 10 is spaced from handle 120, as shown in FIG. 11, and is then commanded to transport connector module 10 together with payload 95 secured therewith, as shown in FIG. 12, to first holding station 107.

Alternatively, the two grabbers 77 may be configured with a reduced diameter indentation 78 defining a conical tip 81. While the two grabbers 77 are outwardly displaced, conical tip 81 strikes tab 49 of the flexion initiating element and locking panel 31 is caused to flex and to become disengaged from tab 141 of handle 120. In addition, due to the accurate longitudinal displacement of the grabbers 77, a detent laterally protruding inwardly from a wall of a secondary bore 46 is received within the corresponding indentation 78 of the outwardly displaced grabber and is frictionally engaged with the grabber body. This frictional engagement with the detent ensures that grabber 77 will remain in an outward position and locking panel 31 will remain disengaged from tab 141 of handle 120 during a transfer action.

At first holding station 107, terminal link 56 is commanded to position the rearward side opening of entryways 7 and 8 (FIG. 2) of the transported connector module in alignment with the two protruding parts, respectively, of handle 120. Terminal link 56 is then commanded to be linearly displaced to undergo another trans-connector movement until the two protruding parts are received within entryways 7 and 8 to a maximum extent. Controller 65 then commands operation of motor 82, causing displacement of the two grabbers 77 in opposite laterally inward directions, to release the force applied onto the corresponding tab 49 of the flexion initiating element. When the two protruding parts are received within entryways 7 and 8, respectively, to a maximum extent, aperture 39 of locking panel 31 is aligned with tab 141 of handle 120. Thus tab 141 becomes engaged with aperture 39 when the force applied to the flexion initiating element is released, and connector module 10 becomes securely engaged with handle 120. Terminal link 56 is afterwards displaced in order to perform an additional exchange operation.

In another embodiment, locking panel 31 becomes flexed to become engaged or disengaged with the handle by means of an electromagnetically extendible plunger, for example a solenoid, which is normally biased in a retracted position by a compression spring.

The coupling unit housed with the terminal link of the robotic arm is commanded by the controller to transmit an energization inducing wireless signal following the trans-connector movement to a power source housed within the structure of the connector module. Current then flows from the power source to activate the plunger and to induce a sufficiently strong magnetic field that causes the plunger to be extended and to overcome the biasing force of the compression spring.

The plunger may be normally retracted within a grabber and, when activated, may laterally protrude therefrom through a dedicated passageway formed in the structure of the connector module. Alternatively, the plunger may be housed within a dedicated passageway formed in the connector module structure, through which it is extendable. Following transmission of the energization inducing signal, the plunger is adapted to extend and to contact the locking panel. The coupling unit is subsequently commanded by the controller to transmit a wireless deactivation signal, whereupon the plunger returns to its normal retracted position.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A payload exchange facilitating connector module, comprising:
a) a structure secured to a payload;
b) a locking member operatively connected to said structure;
c) a locking initiating element that is settable in force transmitting relation with said locking member; and
d) two guiders configured to urge an interface element of two different external positioning components, respectively, to undergo linear and non-rotatable relative motion exclusively with respect to said structure, until said locking initiating element is set in force transmitting relation with said locking member to cause said locking member to become coupled with a dedicated element of a first of said positioning components, or following decoupling of said locking member from said dedicated element to facilitate payload exchange.

2. The connector module according to claim 1, wherein
a) said structure is engageable by the interface element of each of said two different positioning components such that said structure is engageable by the interface element of only one of said two different positioning components at any given time, and is engageable by a second of said positioning components when said locking member is decoupled from said first positioning components to facilitate payload exchange; or
b) the interface element of a second of said positioning components by which the structure is engageable and transportable is a grabber of a robotic arm; or
c) wherein the interface element of a first of said positioning components is a protruding part of a first handle fixed to the unmanned vehicle or a protruding part of a second handle fixed to a holding station.

3. The connector module according to claim 1, wherein the payload is loadable or is automatically loadable onto an unmanned vehicle.

4-6. (canceled)

7. The connector module according to claim 2, wherein each of said two guiders is a linearly extending entryway formed within the structure.

8. The connector module according to claim 7, wherein
a) a first entryway receives the protruding part of the first or second handle and a second entryway receives the grabber; or
b) the protruding part has a discontinuous shape in cross section and the first entryway is shaped complementarily to the protruding part, and the grabber has a discontinuous shape in cross section and the second entryway is shaped complementarily to the grabber, to prevent rotatable motion; or
c) two first entryways receive the protruding parts, respectively, of the first or second handle and two second entryways receives two grabbers, respectively, of the robotic arm; or
d) the protruding part of the first or second handle is receivable in a first entryway prior to introduction of the grabber into a second entryway.

9-11. (canceled)

12. The connector module according to claim 1, wherein the structure is externally or integrally secured to the payload.

13. (canceled)

14. The connector module according to claim 8, wherein the locking member is a flexible locking panel with one free end that is unattached to said structure, the free end of said locking panel being engageable with the first handle to secure the connector module to the unmanned vehicle or with the second handle to secure the connector module to the holding station.

15. The connector module according to claim 14, wherein the locking initiating element is a flexion initiating element,
a) a portion of said flexion initiating element being normally spaced from the locking panel and being settable in force transmitting relation therewith following linear insertion of the grabber within the second entryway to cause the locking panel to flex and to become disengaged from the first handle or from the second handle; or
b) the flexion initiating element being attached to the locking panel and has a first horizontal portion and a second vertical portion extending from said first portion, said second portion being normally positioned within the secondary bore and being settable in force transmitting relation with the locking panel following linear insertion of the grabber within the main entryway region of the second entryway and lateral displacement of the grabber into the secondary bore to displace said second portion; or
c) the flexion initiating element being an electromagnetically extendible plunger that is adapted to contact the locking panel.

16. The connector module according to claim 15, wherein the locking panel is engageable with the dedicated element of the first handle or of the second handle when the portion of the flexion initiating element ceases to be in force transmitting relation with the locking panel.

17. The connector module according to claim 15, wherein the second entryway is configured with a secondary bore outwardly positioned from, but in communication with, a main entryway region of the second entryway.

18-19. (canceled)

20. The connector module according to claim 15, wherein
a) the plunger is normally retracted within the grabber and laterally protrudes therefrom through a dedicated passageway formed in the structure following transmission of an energization inducing signal; or
b) the plunger is housed in a dedicated passageway formed in the structure and is extended following transmission of an energization inducing signal to contact the locking panel.

21. (canceled)

22. The connector module according to claim 2, wherein the interface element of a second of said positioning components by which the structure is engageable and transportable is a recessed element of a robotic arm or
the interface element of a first of said positioning components is a recessed element of a first handle fixed to the unmanned vehicle or a recessed element of a second handle fixed to a holding station.

23. (canceled)

24. The connector module according to claim 1, further comprising a panel formed with a plurality of conductors to provide an electrical connection with given contacts of the payload and to thereby facilitate transmission of data to a compatible receiver.

25. The connector module according to claim 1, wherein the locking initiating element is set in force transmitting relation with the locking member by a screwing or twisting action.

26. A payload exchange system, comprising the connector module according to claim 1, and a robotic arm for transporting the connector module when the locking member is decoupled from the first positioning components, wherein a terminal link of said robotic arm comprises a coupling unit for controllably setting the locking initiating element in force transmitting relation with the locking member following guider cooperating linear displacement of the interface element of the second of said positioning components.

27. The payload exchange system according to claim 26, wherein the robotic arm comprises a controller for controllably displacing links of the robotic arm by coordinated actions to approach the connector module and for commanding operation of the coupling unit once the terminal link is separated from a reference point of the connector module by a predetermined distance.

28. The payload exchange system according to claim 27, further comprising an information center associated with a docking station for acquiring data as to docking status of an unmanned vehicle approaching said docking station and for transmitting a docking indicating signal to the controller which is indicative that an unmanned vehicle carrying the payload has been fully docked and that an exchange operation is to be initiated.

29. The payload exchange system according to claim 26, wherein the coupling unit comprises a motor for transmitting torque via a screw and a threaded connection to cause lateral displacement of the interface element of the second of said positioning components to thereby set the locking initiating element in force transmitting relation with the locking member.
